(19) United States
(12) Patent Application Publication
(10) Pub. No.: US 2026/0195491 A1
(43) Pub. Date: Jul. 9, 2026

(54) OBFUSCATION IMPLEMENTATION METHOD, RECORDING MEDIUM AND DEVICE FOR PERFORMING THE OBFUSCATION

(71) Applicant: Foundation of Soongsil University-Industry Cooperation, Seoul (KR)

(72) Inventors: Haehyun CHO, Busan (KR); Dong Ho LEE, Sejong (KR)

(73) Assignee: Foundation of Soongsil University-Industry Cooperation, Seoul (KR)

(21) Appl. No.: 18/843,129

(22) PCT Filed: Dec. 22, 2023
(86) PCT No.: PCT/KR2023/021413

§ 371 Date: Aug. 30, 2024

(30) Foreign Application Priority Data
Jul. 6, 2023 (KR) 10-2023-0087857

(51) Int. Cl. G06F 21/84; G06F 21/10; G06F 21/14; G06F 21/60

(52) U.S. Cl. CPC G06F 21/84; G06F 21/1066; G06F 21/14; G06F 21/60; G06F 2221/2125

(57) ABSTRACT

The obfuscation implementation method in an obfuscation implementation apparatus for preventing a reverse obfuscation attack on an application of an Android terminal includes separating at least a portion of code included in the application and storing it in an external server, and hiding a string corresponding to the separated code in a data storage space prepared in advance; and protecting a screen element of the Android terminal. This can prevent deobfuscation attacks on applications by attackers through static analysis of Android applications as well as dynamic analysis.

### DESCRIPTION

### Technical Field

The present invention relates to an obfuscation implementation method for preventing a reverse obfuscation attack on an application of an Android terminal, a recording medium and an apparatus for performing the same.

### Background Art

As the use of mobile devices increases, so do security threats. In particular, various security issues such as personal information leakage continue to occur in applications for Android terminals.

Research is being conducted to obfuscate application codes to solve security issues. Specifically, obfuscation techniques refer to methods that make it difficult for attackers or unauthorized accessors to understand or modify the source code of software. In other words, obfuscation techniques are a task that reduces the readability of code while maintaining the structure and logic of the source code.

Among these obfuscation techniques, the most representative methods include techniques such as modifying or hiding source codes through code obfuscation and application self-obfuscation to defend against reverse obfuscation attacks such as decompilation or debugging.

However, as obfuscation technologies develop, reverse obfuscation technologies that utilize static or dynamic analysis of applications are also rapidly developing, making existing obfuscation technologies vulnerable to reverse obfuscation attacks.

Therefore, a new obfuscation technique that can protect personal information from existing reverse obfuscation technologies is needed.

### RELATED ART

Korean Patent Registration No. 10-1234591

### DISCLOSURE

### Technical Issues

The present technology was developed to solve such problems, and the purpose of the present invention is to provide an obfuscation implementation method capable of preventing an attacker's deobfuscation attack on an application through static analysis of an Android application as well as dynamic analysis, and a recording medium and apparatus for performing the same.

### Technical Solution

In order to achieve the above object, according to one embodiment of the present invention, an obfuscation implementation method in an obfuscation implementation apparatus for preventing a reverse obfuscation attack on an application of an Android terminal comprises separating at least a portion of code included in the application and storing it in an external server, and hiding a string corresponding to the separated code in a data storage space prepared in advance; and protecting a screen element of the Android terminal.

The separating the code comprises identifying data with a possibility of data leakage by performing static contamination analysis on the application, wherein the data with a possibility of data leakage may be data having flow starting from a source, which is an entry point of the static contamination analysis, to a sink through which data flows out.

Further, a file of the code is a file having an extension of dex, wherein separating the code may be separating a dex file of the code corresponding to the identified data into an SC (sensitive) dex file, a UDC (User Define Class) dex file, and a Classes dex file.

The hiding may comprise extracting the string from the file of the separated code, identifying a location where the extracted string is to be inserted in the data storage space, and inserting the extracted string into the data storage space, repackaging it, and then signing it using a signature, thereby generating an Android application package (APK) file in which the string is hidden.

Further, the protecting the screen element may comprise changing a screen element, which is information output through a screen, by using at least one of a plurality of obfuscation techniques prepared in advance.

In order to achieve the above object, according to one embodiment of the present invention, a computer-readable recording medium has recorded thereon a computer program for performing the obfuscation implementation method according to the present invention.

Meanwhile, in order to achieve the above object, according to one embodiment of the present invention, an obfuscation implementation apparatus for preventing a reverse obfuscation attack on an application of an Android terminal may comprise a code separation unit configured to separate at least a portion of code included in the application and store it in an external server; a hiding unit configured to hide a string corresponding to the separated code in a data storage space prepared in advance; and a screen protection unit configured to protect a screen element of the Android terminal.

The code separation unit separates the code by performing static contamination analysis on the application to identify data with a possibility of data leakage, wherein the data with a possibility of data leakage may be data having flow starting from a source, which is an entry point of the static contamination analysis, to a sink through which data flows out.

Further, a file of the code is a file having an extension of dex, wherein the code separation unit may separate a dex file of the code corresponding to the identified data into an SC (sensitive) dex file, a UDC (User Define Class) dex file, and a Classes dex file.

The hiding unit may extract the string from the file of the separated code, identify a location where the extracted string is to be inserted in the data storage space, and insert the extracted string into the data storage space, repackages it, and then sign it using a signature, thereby generating an Android application package (APK) file in which the string is hidden.

Further, the screen protection unit may change a screen element, which is information output through a screen, using at least one of a plurality of obfuscation techniques prepared in advance.

### Advantageous Effects

According to one aspect of the present invention described above, by providing a method for implementing obfuscation, a recording medium and an apparatus for performing the same, it is possible to prevent a reverse obfuscation attack on an application by an attacker through static analysis of an Android application as well as dynamic analysis.

### BRIEF DESCRIPTION OF DRAWINGS

These and/or other aspects will become apparent and more readily appreciated from the following description of the embodiments, taken in conjunction with the accompanying drawings in which:

FIG. 1 is a block diagram illustrating the configuration of an obfuscation implementation apparatus according to an embodiment of the present invention;

FIG. 2 is a diagram illustrating an obfuscation implementation process performed by an obfuscation implementation apparatus according to an embodiment of the present invention;

FIG. 3 is a diagram illustrating an overall process of separating codes by a code separation unit according to an embodiment of the present invention;

FIG. 4 is a diagram illustrating static contamination analysis performed by a code separation unit according to an embodiment of the present invention;

FIG. 5 is an exemplary diagram illustrating a process of identifying data to separate codes by a code separation unit according to an embodiment of the present invention;

FIG. 6 is a diagram illustrating a specific process of separating codes by a code separation unit according to an embodiment of the present invention;

FIGS. 7 to 9 are exemplary diagrams illustrating various obfuscation techniques to protect screen elements used by a screen protection unit according to an embodiment of the present invention;

FIG. 10 is a diagram illustrating an overall process of a hiding unit hiding data according to an embodiment of the present invention;

FIGS. 11 to 14 are diagrams illustrating a result of hiding data by a hiding unit according to an embodiment of the present invention,

FIG. 15 is a diagram illustrating a flow chart for explaining an obfuscation implementation method performed in an obfuscation implementation apparatus according to one embodiment of the invention, and

FIG. 16 is a graph showing experimental results for explaining the effect of an obfuscation implementation method according to one embodiment of the present invention.

### DETAILED DESCRIPTION OF EMBODIMENTS

The detailed description of the invention set forth below refers to the accompanying drawings which illustrate specific embodiments in which the invention may be practiced. These embodiments are described in sufficient detail to enable those skilled in the art to practice the invention. It should be understood that the various embodiments of the invention, while different from one another, are not necessarily mutually exclusive. For example, specific shapes, structures, and features described herein may be implemented in other embodiments without departing from the spirit and scope of the invention. It should also be understood that the positions or arrangements of individual components within each disclosed embodiment may be changed without departing from the spirit and scope of the invention. Accordingly, the detailed description set forth below is not intended to be limiting, and the scope of the invention is defined only by the appended claims, along with the full scope of equivalents to which such claims are entitled, if properly so described. Like reference numerals in the drawings designate the same or similar functionality throughout the several aspects.

The components according to the present invention are components defined by functional distinction rather than physical distinction, and can be defined by the functions each performs. Each component may be implemented by hardware or program code and processing unit performing each function, and the functions of two or more components may be implemented by being included in one component. Therefore, the names given to the components in the following embodiments are not given to physically distinguish each component, but to imply a representative function performed by each component, and it should be noted that the technical idea of the present invention is not limited by the names of the components.

Hereinafter, a preferred embodiment of the present invention will be described in detail with reference to the attached drawings.

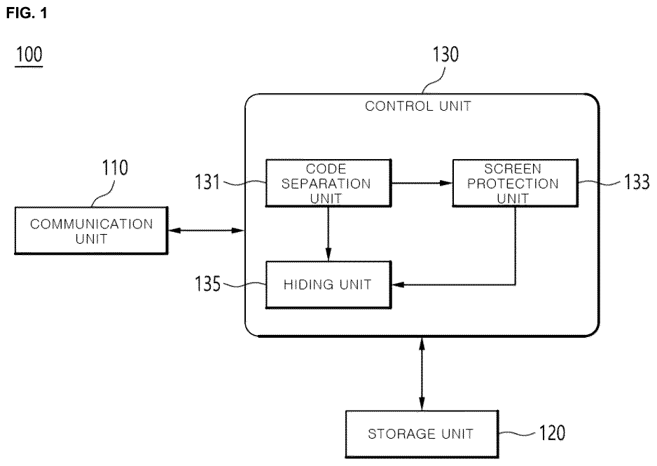

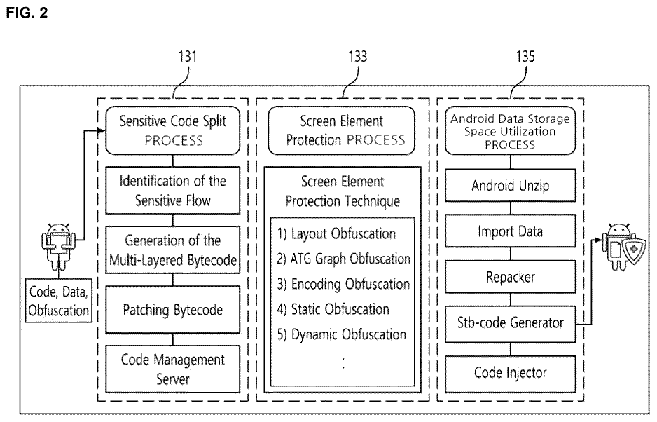

FIG. 1 is a block diagram for explaining the configuration of an obfuscation implementation apparatus 100 according to one embodiment of the present invention, and FIG. 2 is a diagram for explaining an obfuscation implementation process performed by an obfuscation implementation apparatus 100 according to one embodiment of the present invention.

The obfuscation implementation apparatus 100 (hereinafter, referred to as the apparatus) according to this embodiment is provided to prevent a reverse obfuscation attack on an application of an Android terminal.

To this end, the apparatus 100 according to this embodiment may comprise a communication unit 110, a storage unit 120, and a control unit 130. In addition, the apparatus 100 may be installed and executed with software (application) for performing an obfuscation implementation method, and the communication unit 110, the storage unit 120, and the control unit 130 may be controlled by the software (application) for performing an obfuscation implementation method.

At this time, the apparatus 100 may be a separate terminal or a part of a module of the terminal. In addition, the configuration of the communication unit 110, storage unit 120, and control unit 130 may be formed as an integrated module or may be formed of one or more modules. However, conversely, each configuration may be formed as a separate module.

In addition, the apparatus 100 may be mobile or fixed. This apparatus 100 may be in the form of a server or an engine, and may be called by other terms such as a device, an apparatus, a terminal, a UE (user equipment), an MS (mobile station), a wireless device, a handheld device, etc. In addition, the apparatus 100 may execute or produce various software based on an operating system (OS), that is, a system. Here, the operating system is a system program for enabling software to use the hardware of the apparatus, and may include all mobile computer operating systems such as Android OS, iOS, Windows Mobile OS, Bada OS, Symbian OS, and Blackberry OS, as well as computer operating systems such as Windows, Linux, Unix, MAC, AIX, and HP-UX.

The communication unit 110 of the present invention is provided to transmit or receive information required in the process of implementing obfuscation in the control unit 130 to the outside or from the outside.

The communication unit 110 may transmit and receive information with an external server, which is a server provided externally. Specifically, the communication unit 110 according to the present embodiment may store at least some of the codes included in the application in an external server under the control of the control unit 130.

In addition, the communication unit 110 may request and receive codes stored in an external server under the control of the control unit 130 and transmit them to the control unit 130.

Meanwhile, the storage unit 120 records a program for implementing an obfuscation method. In addition, the control unit 130 temporarily or permanently stores the data processed, and may include a volatile storage medium or a non-volatile storage medium, but the scope of the present invention is not limited thereto.

The storage unit 120 stores data accumulated while performing the obfuscation implementation method.

Meanwhile, the control unit 130 is provided to control the entire process of providing the obfuscation implementation method. This control unit 130 may comprise a code separation unit 131, a screen protection unit 133, and a hiding unit 135.

First, the code separation unit 131 may separate at least a portion of the code included in the application and store it in an external server. At this time, the code separation unit 131 may delete the separated code on the Android terminal.

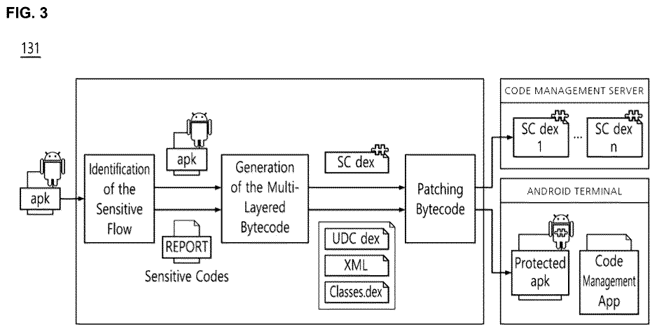

FIG. 3 is a drawing for explaining the overall process of the code separation unit 131 separating the code according to one embodiment of the present invention.

The code separation unit 131 may first perform static contamination analysis on the application to separate the code and identify data with a possibility of data leakage.

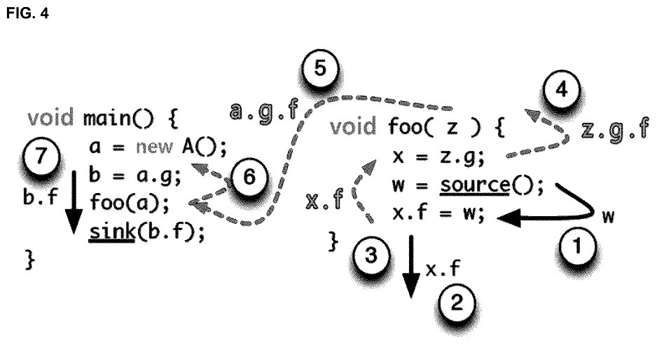

FIG. 4 is a diagram for explaining the static contamination analysis performed by the code separation unit 131. As shown in FIG. 4, the context, flow, field, object detection, and life cycle can be recognized through the static contamination analysis tool FlowDroid.

If there is a flow starting from the source, which is the entry point of the static contamination analysis tool FlowDroid, to the sink where data flows out, data is leaked. In most applications, sensitive user information is leaked through the path starting from this source to the sink.

Accordingly, the code separation unit 131 can detect information leakage through the context, flow, field, and object sensitivity by tracing the flow from the source to the sink using the static contamination analysis tool FlowDroid, generating an . xml file and executing static analysis.

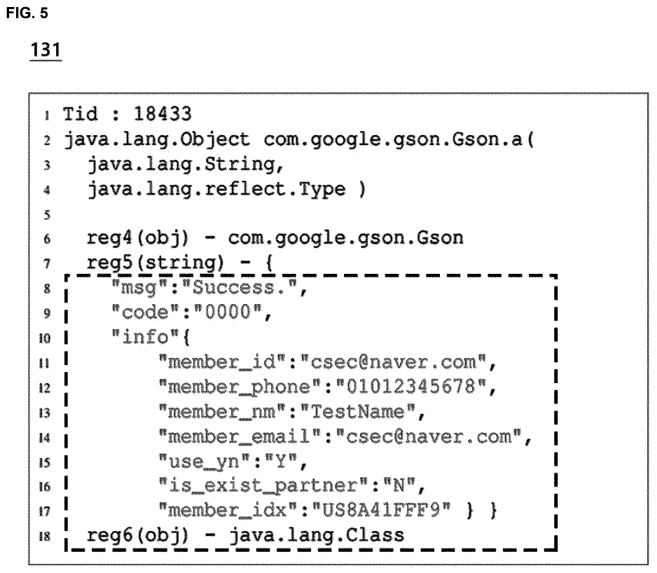

Accordingly, the code separation unit 131 identifies data that has a flow starting from the source, which is the entry point of the static contamination analysis tool FlowDroid, to the sink through which the data flows out, as data with a possibility of data leakage. FIG. 5 is an example diagram illustrating the result of the code separation unit 131 identifying data with a possibility of data leakage through static contamination analysis.

The code separation unit 131 can separate the code files corresponding to the data identified as having a possibility of data leakage into a predetermined number.

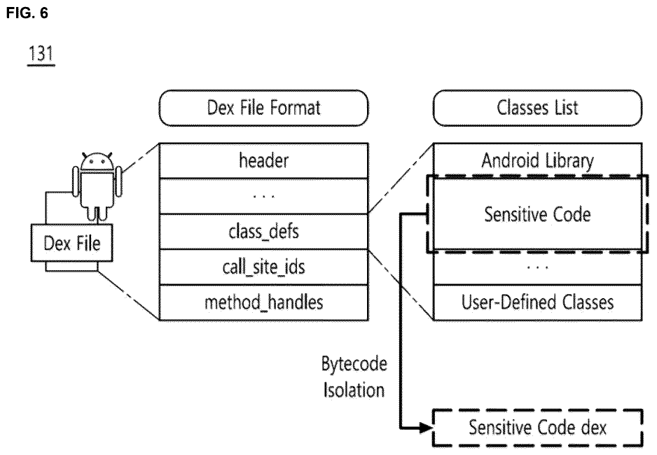

FIG. 6 is a drawing illustrating the process of the code separation unit 131 separating the code. As illustrated in FIG. 6, the code separation unit 131 can separate the dex file with the extension of dex as the code file corresponding to the identified data into three.

More specifically, the code separation unit 131 selects a class to be separated, that is, protected from the data identified as having a possibility of data leakage.

At this time, when selecting the class to be separated, there may be a case where there are a plurality of codes in which important codes exist. If there are a plurality of classes to be separated, the code separation unit 131 may select one class based on the number of instructions included in each of the plurality of classes. For example, the code separation unit 131 may finally select the class containing the largest number of instructions among the plurality of classes as the class to be separated.

The code separation unit 131 may separate one dex file corresponding to the selected class into an SC (sensitive Code) dex file, a UDC (User Define Class) dex file, and other Classes dex file.

Since there is a hidden code in the SC dex file among the separated dex files, the code separation unit 131 may store the corresponding SC dex file in an external server.

After the SC dex file is stored in the external server in this way, a communication process with the external server where the separated code is stored is required in order to execute the corresponding application.

Specifically, in an Android terminal, an application without separated code does not operate normally, and the application is executed normally only when the separated code is called through an external server with the consent of the user (owner of the Android terminal).

Even if an attacker performs static analysis on the corresponding application through this code separation unit 131, the analysis cannot be performed on the code stored in the external server.

In addition, when dynamic analysis is performed, the code stored and protected through the external server should also be executed. However, since the execution of the code requires the user's consent, the analysis of the application can be prevented from a deobfuscation attack through dynamic analysis by an attacker.

Meanwhile, the screen protection unit 133 protects the screen elements of the Android terminal to prevent deobfuscation through dynamic analysis.

The screen protection unit 133 can change the screen elements, which are information output through the screen, by using at least one of a plurality of pre-prepared obfuscation techniques.

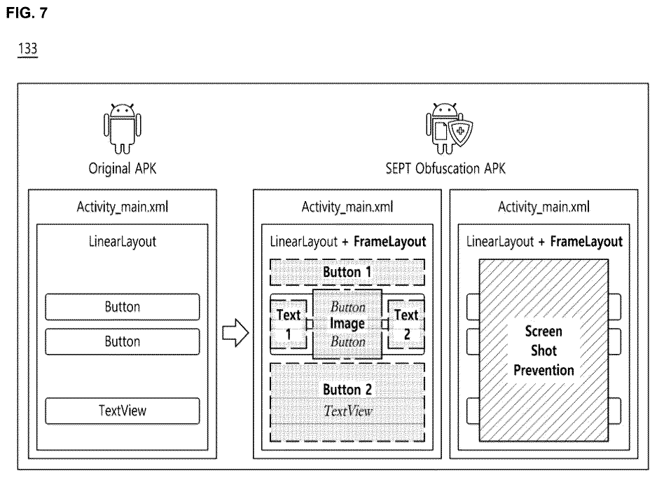

Specifically, FIGS. 7 to 9 are exemplary diagrams illustrating various obfuscation techniques used by the screen protection unit 133 to protect the screen elements.

Specifically, the screen protection unit 133 according to the present embodiment protects the Android user interface environment from deobfuscation tools. In particular, it can prevent deobfuscation and analysis using dynamic analysis tools such as Android Monkey and Android Automator.

The obfuscation technique used by the screen protection unit 133 to change the screen elements may include at least one of the layout addition technique, the linear layout hiding technique, the activity tree graph (ATG) complexity increase technique, the API hiding technique, the overlay view layout technique, and the screenshot prevention technique.

The layout addition technique is a method in which the screen protection unit 133 adds the linear layout and the frame layout to the existing original APK.

For example, as shown in FIG. 7, the original APK can identify the linear layout and the user interface elements including two buttons and the text view.

In the case where the screen protection unit 133 changes the screen elements according to the layout addition technique, the screen protection unit 133 may change the screen elements by adding Button 1, Button 2, Text 1, and Text 2 image user interfaces to the original APK as shown in FIG. 7 to prevent dynamic analysis.

In addition, the screen protection unit 133 may add a Frame Layout to prevent layout analysis.

In addition, according to the screenshot prevention technique, the screen protection unit 133 may prevent screenshots from tools using capture as shown in FIG. 7 by using the flag_secure code in application information theft using snapshots. Therefore, the screen protection unit 133 can prevent deobfuscation from dynamic analysis tools that extract application information through screenshots.

The screen protection unit 133 can apply Java reflection by generating AseetManager in the layout file according to the linear layout hiding technique.

In addition, the screen protection unit 133 may use the activity tree graph (hereinafter referred to as ATG) complexity-increasing technique.

When changing screen elements using the ATG complexity-increasing technique, the screen protection unit 133 can expand the ATG by inserting nodes and edges into the ATG.

In addition, when changing screen elements using the API hiding technique, the screen protection unit 133 can change screen elements by applying the API hiding obfuscation technique to the applied codes or by preventing ATG-related API identification when dynamically loading after patching.

In addition, the screen protection unit 133 can change screen elements by inserting dummy codes into the Activity section.

In addition, the screen protection unit 133 can change screen elements by hiding buttons or text views included in the original APK according to the overlay view layout technique.

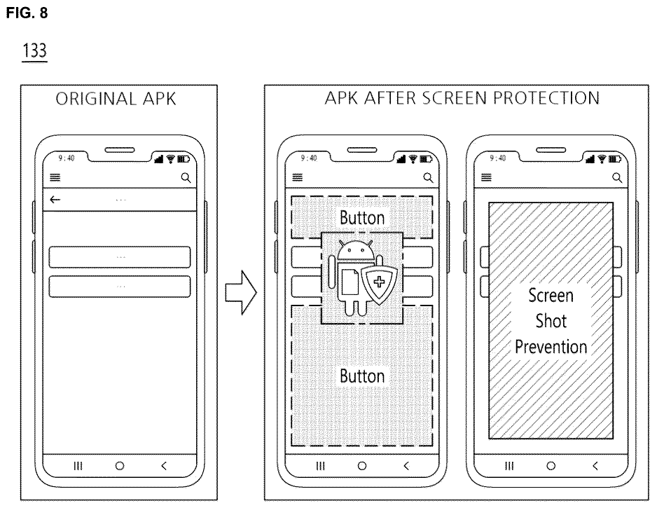

In addition, the screen protection unit 133 can change screen elements by combining two or more techniques among the above plurality of deobfuscation techniques. For example, as shown in FIG. 8, the screen protection unit 133 can change screen elements by adding an image user interface including a plurality of buttons to the original APK and simultaneously using a screenshot prevention technique.

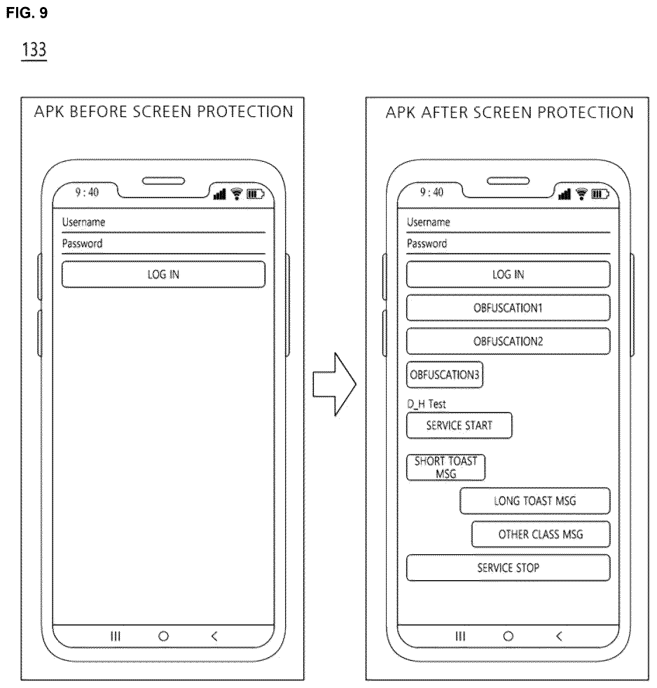

FIG. 9 is a diagram comparing screen elements output before performing obfuscation and screen elements output after performing obfuscation by changing screen elements through the screen protection unit 133.

Meanwhile, the hiding unit 135 is provided to hide a string corresponding to an important code.

In other words, the hiding unit 135 can perform code obfuscation by embedding important data and resources in other data, image files, audio files, etc. by utilizing the characteristics of the application.

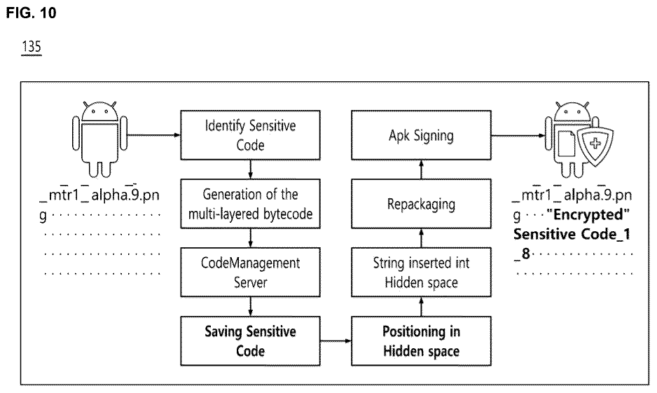

FIG. 10 is a diagram explaining the overall process of the hiding unit 135 hiding data. The hiding unit 135 hides a string corresponding to a code separated by the code separation unit 131 in a data storage space prepared in advance.

The hiding unit 135 can extract a string from a file of separated code and identify the location where the extracted string is to be inserted in the data storage space. For example, the extracted string may mean a string value used for a class selected by the code separation unit 131.

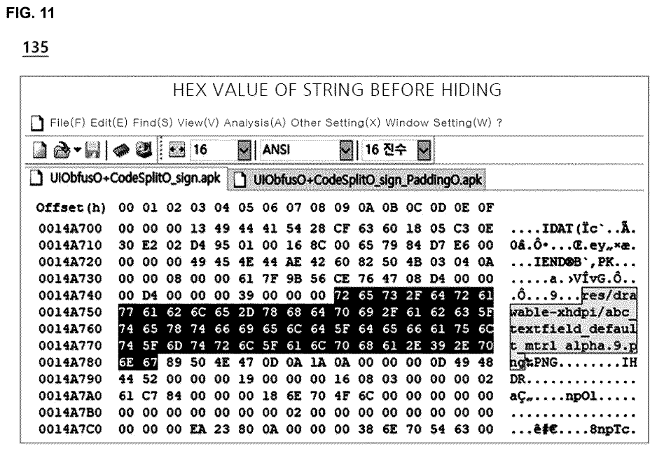

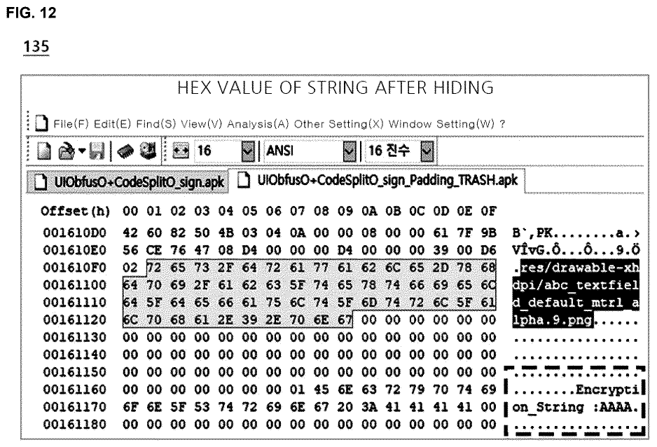

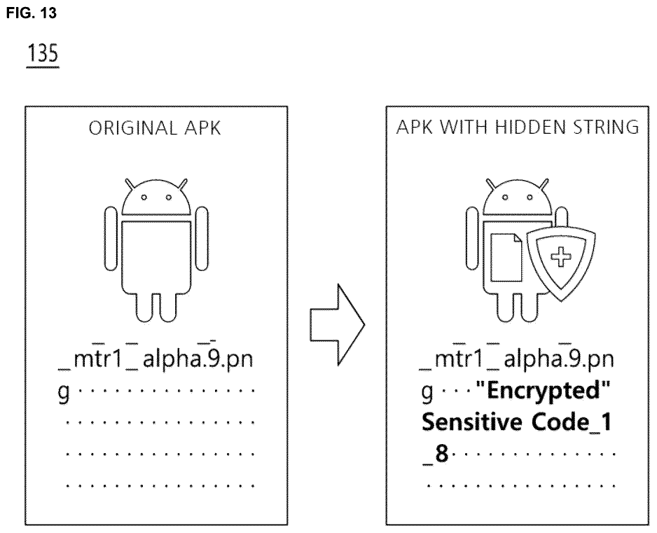

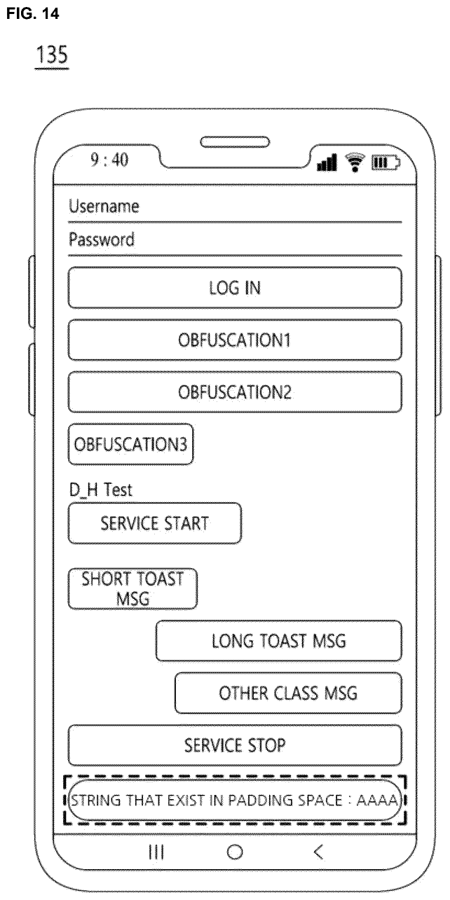

FIGS. 11 to 14 are exemplary diagrams for explaining the process and result of the hiding unit 135 hiding data. More specifically, FIG. 11 is a diagram illustrating a Hex value before obfuscation of an application is performed through the hiding unit 135, and FIG. 12 is a diagram illustrating a Hex value after obfuscation of an application is performed through the hiding unit 135. In addition, FIG. 13 is a diagram comparing APKs before and after the obfuscation of an application is performed through the hiding unit 135, and FIG. 14 is an exemplary diagram illustrating a string output after the obfuscation of an application is performed through the hiding unit 135.

The data storage space where the hidden unit 135 inserts the string may be a space behind the Android image data that can be secured during the Android optimization process, as shown in FIGS. 11 and 12.

The hiding unit 135 inserts the extracted string into the identified data storage space, repackages it, and then signs it using a signature. The signing by the hiding unit 135 using the signature may be using the “Encrypted_String” signature, as shown in FIG. 12.

By completing the signing, the hiding unit 135 can generate an Android application package (APK) file in which the string is hidden, as shown in FIG. 13.

Therefore, unlike conventional obfuscation techniques that obfuscate a portion of code or make it difficult to analyze, the hiding unit 135 can protect application code in the form of bytecode with low analysis difficulty by storing a string corresponding to the code in a data storage space within the application file structure.

The hidden string can be dynamically loaded and executed with the user's consent when the application is executed.

More specifically, when the application is executed, the hidden string behind the signature is retrieved using the “Encrypted” signature so that the application can be executed normally.

Through the above configuration, the apparatus 100 according to the present embodiment can provide a more powerful obfuscation effect than conventional obfuscation tools by grafting a code separation technology that stores a portion of the code externally, a DSSU (Data Storage Space Utilization) technology that hides a string corresponding to the code stored externally, and a SEP (Screen Element Protection) technology that protects screen elements, thereby hiding classes and data that can be statically analyzed and dynamically analyzed inside and outside the Android terminal.

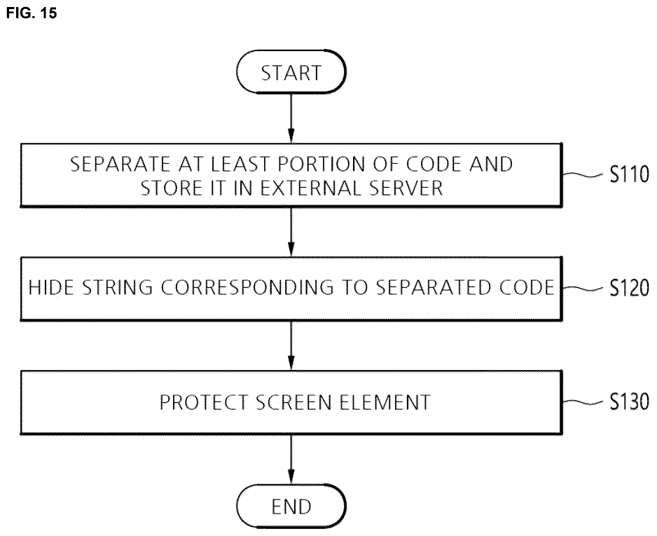

Meanwhile, FIG. 15 is a flow chart for explaining an obfuscation implementation method performed in an obfuscation implementation apparatus 100 according to one embodiment of the present invention. Since the obfuscation implementation method according to one embodiment of the present invention is performed on a configuration substantially identical to that of the obfuscation implementation apparatus 100 illustrated in FIG. 1, the same reference numerals are assigned to the same components as those of the obfuscation implementation apparatus 100, and repeated descriptions are omitted.

The obfuscation implementation method according to this embodiment comprises a step (S110) of separating at least a portion of a code and storing it in an external server, a step (S120) of hiding a string corresponding to the separated code, and a step (S130) of protecting a screen element.

In the step (S110) of separating at least a portion of the code and storing it in an external server, the code separation unit 131 may separate at least a portion of the code included in the application and store it in an external server.

In the step (S110) of separating at least a portion of the code and storing it in an external server, the code separation unit 131 may perform a static contamination analysis on the application to identify data with a possibility of data leakage.

At this time, the data with a possibility of data leakage may be data having a flow that starts from a source, which is the entry point of the static contamination analysis, to a sink through which data flows out.

In addition, in the step (S110) of separating at least a portion of the code and storing it in an external server, the code separation unit 131 may separate a file of code corresponding to the identified data in a predetermined number.

Here, the code file is a file with the extension of dex, and in the step (S110) of separating at least a part of the code and storing it in an external server, the code separation unit 131 may separate the dex file of the code into an SC (sensitive) dex file, a UDC (User Define Class) dex file, and a Classes dex file.

Meanwhile, the step (S120) of hiding the string corresponding to the separated code may be a step in which the hiding unit 135 hides the string corresponding to the separated code in a data storage space prepared in advance.

In the step (S120) of hiding the string, the hiding unit 135 may extract the string from the separated code file and identify the location where the extracted string is to be inserted in the data storage space.

In the step of hiding the string (S120), the hiding unit 135 inserts the extracted string into the data storage space, repackages it, and then signs it using a signature, thereby generating an Android application package (APK) file in which the string is hidden.

Meanwhile, the step of protecting the screen element (S130) may be a step in which the screen protection unit 133 protects the screen element of the Android terminal.

In the step of protecting the screen element (S130), the screen protection unit 133 may change the screen element, which is information output through the screen, by using at least one of a plurality of obfuscation techniques prepared in advance.

The obfuscation implementation method of the present invention may be implemented in the form of program instructions that can be executed through various computer components and may be recorded on a computer-readable recording medium. The computer-readable recording medium may include program instructions, data files, data structures, etc. alone or in combination.

The program instructions recorded on the above computer-readable recording medium may be those specially designed and configured for the present invention or may be those known and available to those skilled in the art of computer software.

Examples of computer-readable recording medium comprise magnetic media such as hard disks, floppy disks, and magnetic tapes, optical recording media such as CD-ROMs and DVDs, magneto-optical media such as floptical disks, and hardware devices specially configured to store and execute program instructions such as ROMs, RAMs, and flash memories.

Examples of the program instructions include not only machine language codes such as those generated by a compiler, but also high-level language codes that can be executed by a computer using an interpreter, etc. The hardware devices may be configured to operate as one or more software modules to perform processing according to the present invention, and vice versa.

Although various embodiments of the present invention have been illustrated and described above, the present invention is not limited to the specific embodiments described above, and various modifications can be made by those skilled in the art without departing from the gist of the present invention claimed in the claims, and such modifications should not be individually understood from the technical idea or prospect of the present invention.

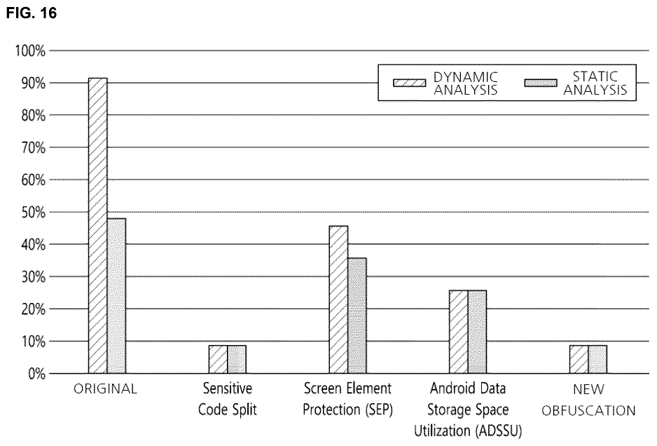

Meanwhile, FIG. 16 is a graph illustrating the results of an experiment to explain the effect of an obfuscation implementation method according to an embodiment of the present invention.

Specifically, FIG. 16 is a graph illustrating the percentages exposed through dynamic analysis and static analysis for an original application (original), an application obfuscated by performing only code separation (Sensitive Code Split), an application obfuscated by performing only screen element protection (SEP), an application obfuscated by performing only data hiding (Android Data Storage Space Utilization (ADSSU)), and an application obfuscated through an obfuscation implementation method according to the present embodiment (new obfuscation).

As can be seen from FIG. 16, it has been proven that the obfuscation implementation method of the present invention, which comprises all three techniques of code separation, screen element protection, and data hiding, can protect important information of an application more effectively.

### REFERENCE NUMERALS

100: obfuscation implementation apparatus 110: communication unit
120: storage unit 130: control unit
131: code separation unit 133: screen protection unit
135: hiding unit

1. An obfuscation implementation method in an obfuscation implementation apparatus for preventing a reverse obfuscation attack on an application of an Android terminal, comprising:
separating at least a portion of code included in the application and storing it in an external server, and hiding a string corresponding to the separated code in a data storage space prepared in advance; and
protecting a screen element of the Android terminal.

2. The method of claim 1, wherein the separating the code comprises,
identifying data with a possibility of data leakage by performing static contamination analysis on the application,
wherein the data with a possibility of data leakage is data having flow starting from a source, which is an entry point of the static contamination analysis, to a sink through which data flows out.

3. The method of claim 2, wherein a file of the code is a file having an extension of dex,
wherein separating the code is separating a dex file of the code corresponding to the identified data into an SC (sensitive) dex file, a UDC (User Define Class) dex file, and a Classes dex file.

4. The method of claim 2, wherein the hiding comprises,
extracting the string from the file of the separated code;
identifying a location where the extracted string is to be inserted in the data storage space; and
inserting the extracted string into the data storage space, repackaging it, and then signing it using a signature, thereby generating an Android application package (APK) file in which the string is hidden.

5. The method of claim 1, wherein the protecting the screen element comprises,
changing a screen element, which is information output through a screen, by using at least one of a plurality of obfuscation techniques prepared in advance.

6. A computer-readable recording medium having recorded thereon a computer program for performing the obfuscation implementation method according to claim 1.

7. An obfuscation implementation apparatus for preventing a reverse obfuscation attack on an application of an Android terminal, comprising:
a code separation unit configured to separate at least a portion of code included in the application and store it in an external server;
a hiding unit configured to hide a string corresponding to the separated code in a data storage space prepared in advance; and
a screen protection unit configured to protect a screen element of the Android terminal.

8. The apparatus of claim 7, wherein the code separation unit separates the code by performing static contamination analysis on the application to identify data with a possibility of data leakage,
wherein the data with a possibility of data leakage is data having flow starting from a source, which is an entry point of the static contamination analysis, to a sink through which data flows out.

9. The apparatus of claim 8, wherein a file of the code is a file having an extension of dex,
wherein the code separation unit separates a dex file of the code corresponding to the identified data into an SC (sensitive) dex file, a UDC (User Define Class) dex file, and a Classes dex file.

10. The apparatus of claim 8, wherein the hiding unit,
extracts the string from the file of the separated code,
identifies a location where the extracted string is to be inserted in the data storage space, and
inserts the extracted string into the data storage space, repackages it, and then signs it using a signature, thereby generating an Android application package (APK) file in which the string is hidden.

11. The apparatus of claim 7, wherein the screen protection unit changes a screen element, which is information output through a screen, using at least one of a plurality of obfuscation techniques prepared in advance.
